(19) United States
(12) Patent Application Publication
(10) Pub. No.: US 2026/0365303 A1
(43) Pub. Date: Nov. 19, 2026

(54) USE OF ROTATING WINGS WITH THE PRINCIPLE OF SELF-ROTATION IN ELECTRIC VERTICAL TAKE-OFF AND LANDING (EVTOL) AIRCRAFT

(71) Applicants: Azeddine BENMERBI, Batna (DZ); Ali BENMERBI, Batna (DZ)

(72) Inventors: Azeddine BENMERBI, Batna (DZ); Ali BENMERBI, Batna (DZ)

(21) Appl. No.: 19/480,412

(22) PCT Filed: May 2, 2024
(86) PCT No.: PCT/DZ2024/050005

§ 371 Date: Oct. 31, 2025

(30) Foreign Application Priority Data
May 2, 2023 (DZ) 230454

(51) Int. Cl. B64C 29/00; B64D 27/34

(52) U.S. Cl. CPC B64C 29/0033; B64D 27/34

(57) ABSTRACT

The use of rotating wings with the principle of self-rotation in electric vertical take-off and landing (eVTOL) aircraft in order to take advantage of the battery power to cover longer distances more rapidly with safe landing of the aircraft in the event of damage due to the temporary lift force generated by the rotating wings as a result of the moment of inertia, and to reduce the air resistance and provide for passenger comfort.

### TECHNICAL FIELD OF THE INVENTION

The invention belongs to the aeronautical engineering field, more specifically to electric-powered vertical take-off and landing aircraft (eVTOL) that combine lift and propulsion control mechanisms. cl BACKGROUND ART (PRIOR ART)

In the current state of the art, an example of an electric flying vehicle is the XPENG AeroHT model—a two-seater vertical take-off and landing aircraft equipped with four fixed electric motors, each driving two propellers. This vehicle is designed for low-altitude flight, capable of operating for approximately 35 minutes with a maximum speed of 135 km/h, and is expected to enter production by 2024 at a price of USD 139,200.

Drawbacks of the Prior Art:
High energy consumption, as the system relies entirely on the four motors to provide both lift and thrust, leading to reduced flight duration and shorter operational range.
Low safety margin, since in the event of a system failure or power loss, the aircraft loses all lift and falls uncontrollably, posing serious risks to occupants.
Limited speed, as most of the propulsion energy is consumed in maintaining lift, resulting in reduced forward thrust.
Aerodynamic inefficiency, requiring the aircraft to tilt forward during flight to achieve forward motion, increasing drag and energy consumption while reducing passenger comfort.

### PURPOSE AND SUMMARY OF THE INVENTION

The primary objective of this invention is to overcome the aforementioned drawbacks of existing eVTOL aircraft by introducing an innovative aerodynamic and mechanical configuration that enhances flight safety, extends operational range, and improves overall energy efficiency.

To achieve these objectives, the invention proposes the following integrated design features:
1. Addition of Autorotative Rotors: Mounted above the aircraft, these rotors operate on the principle of autorotation, wherein airflow passing through the rotor blades during forward flight induces self-sustained rotation. This rotation generates lift without requiring direct mechanical power input, similar to the operation of a gyrocopter.
2. Incorporation of a Variable-Angle Motor Tilting System: The electric propulsion units are mounted on adjustable tilt mechanisms that enable controlled transition between vertical lift and horizontal thrust.
3. Supplementary Fixed Wings Around Motor Mounts: The structure surrounding the motor supports is covered by fixed aerodynamic surfaces, designed to capture additional airflow and provide extra lift during horizontal flight phases.

### DRAWINGS AND FIGURES

The invention will be better understood through the following description, with reference to the attached schematic drawings:

FIG. 1: Three-dimensional perspective view of the flying vehicle in its stationary state.

FIG. 2: Detailed view of the motor tilting mechanism used to vary the inclination angle of the propulsion units.

FIG. 3: Structural view illustrating the autorotative rotor system, including the rotor head and the elements responsible for controlling rotor tilt.

### DETAILED DESCRIPTION OF THE INVENTION

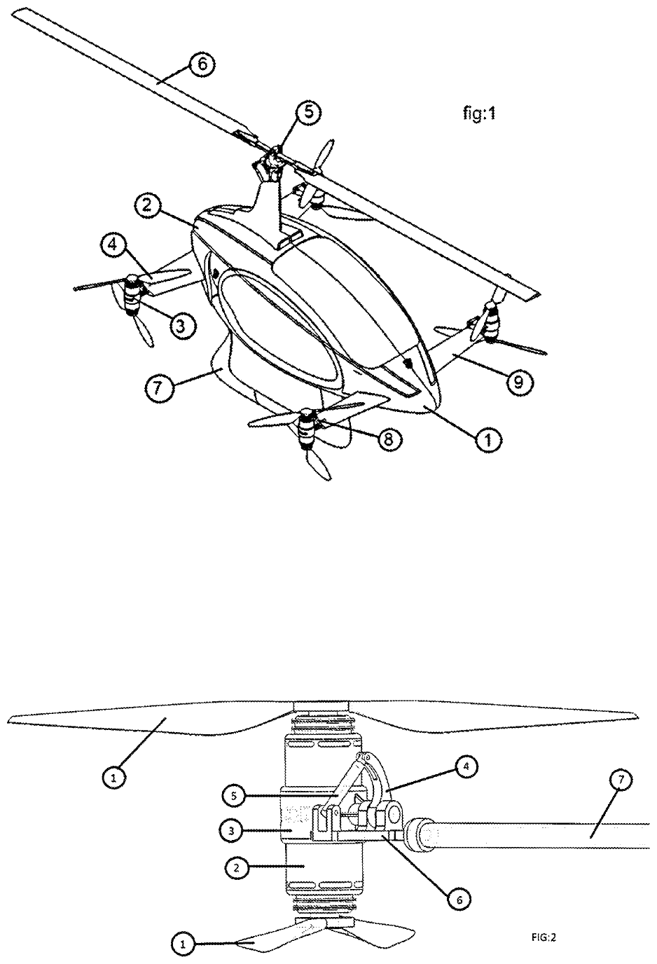

FIG. 1 illustrates the flying vehicle in its stationary configuration. The aircraft comprises a passenger cabin equipped with four seats, flight control devices, and navigation systems. The battery modules are positioned at the rear section, with a dedicated luggage compartment. Four electric motors are mounted around the aircraft, with two on each side. Each motor drives two propellers and is directly attached to the motor tilting device. This tilting device connects to the airframe via a mounting bracket, which is aerodynamically covered by fixed wings to improve airflow utilization and provide additional passive lift.

Above the aircraft, the autorotative rotor system is installed to generate lift during forward motion. This rotor assembly is supported by a rotor head, which is controlled by two electric actuators connected to the flight control stick.

FIG. 2 illustrates the motor tilting mechanism, which operates as follows: The propeller is driven by the electric motor, both of which are mounted on a support bracket. The bracket is connected to a rotational shaft housed within a pivot table containing ball bearings, allowing the motor to tilt smoothly. A linkage arm engages with the support bracket through a toothed connection. This arm is actuated by an electric actuator directly controlled from the pilot's interface. The complete mechanism is attached to the airframe.

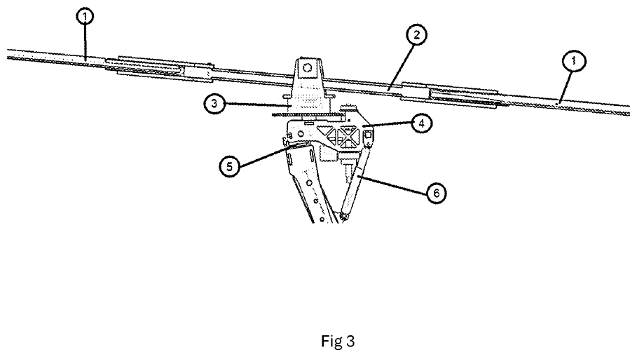

FIG. 3 shows the autorotative rotor assembly and its control components: The rotor blades are mounted on a rotor hub attached to a central cylinder located at the aircraft's center of gravity. The rotor assembly rotates freely around the main rotor shaft supported by a bearing system. The rotor head includes a tilt block that allows the rotor to pivot forward, backward, and laterally. This tilt motion is controlled by two electric actuators connected to the flight control system, enabling the pilot to adjust the rotor's orientation during flight.

### MODE OF OPERATION

Operation of the aircraft requires a certain level of pilot training and familiarity with hybrid rotorcraft control systems, as its behavior differs from conventional airplanes or helicopters.
1. Pre-flight Inspection: The pilot performs a comprehensive check of the aircraft, including verification of battery charge levels, rotor blade condition, and control system functionality.
2. Vertical Take-Off: To initiate take-off, the pilot sets the electric motors to a 90° vertical orientation, generating upward thrust. Power is then gradually increased until the aircraft achieves lift-off and hovers stably.
3. Transition to Forward Flight: After take-off, the pilot adjusts the motor tilt angle between 20° and 30°, producing a forward thrust component that propels the aircraft ahead.
4. Level Flight: As the aircraft gains forward speed, the autorotative rotors begin to self-spin due to airflow passing through their blades. Once sufficient rotor RPM is achieved to sustain lift, the pilot gradually tilts the motors to 180°, making them contribute purely to forward propulsion while lift is generated entirely by the autorotative rotors.
5. Landing: No runway is required. The pilot selects an appropriate landing spot, reverts the motor tilt angle to 90°, and reduces thrust power to achieve a stable vertical descent until touchdown.

1. Integration of autorotative rotors operating on the principle of self-rotation into electric vertical take-off and landing (eVTOL) aircraft.

2. An aircraft according to claim 1, comprising four electric motors mounted laterally on both sides of the airframe, each capable of tilting to vary the angle of inclination, thereby allowing controlled transition between vertical lift and horizontal thrust, in combination with an upper autorotative rotor generating lift during forward flight.

3. The aircraft according to claim 1, characterized by an aerodynamic, streamlined design optimized to minimize air resistance and improve both performance and aesthetics.

4. The aircraft according to claim 1, wherein the four electric motors are equipped with a variable-angle tilting mechanism, allowing the pilot to regulate the balance between lift and propulsion through a motor angle adjustment device.

5. The aircraft according to claim 1, wherein the autorotative rotors generate lift by utilizing airflow induced by the aircraft's forward motion, thus providing passive lift without direct power consumption.

6. The aircraft according to claim 1, further comprising fixed aerodynamic wings integrated around the motor mounts to capture additional airflow and generate supplementary lift, thereby improving flight efficiency and range.
